(19) United States
(12) Patent Application Publication
(10) Pub. No.: US 2009/0283537 A1
(43) Pub. Date: Nov. 19, 2009

(54) Protective Sleeve

(76) Inventors: Barry L. Silverstein, Northbrook, IL (US); Matthew R. Cook, Hinsdale, IL (US); James A. Hubbard, Oak Lawn, IL (US); Kurt M. Wolf, Evanston, IL (US)

Correspondence Address: BRINKS HOFER GILSON & LIONE, P.O. BOX 10395, CHICAGO, IL, 60610, US

(21) Appl. No.: 12/434,998

(22) Filed: May 4, 2009

Related U.S. Application Data
(60) Provisional application No. 61/127,552, filed on May 14, 2008.

(51) Int. Cl. B65D 25/00; B31B 1/14

(52) U.S. Cl. 220/737; 493/56

(57) ABSTRACT

A sleeve is disclosed having a unique wave-like shape that facilitates manufacturing material efficiency and therefore reduces material costs and environmental waste. A blank for a sleeve and a method of making a sleeve are also disclosed. The sleeve, when unassembled and laid flat, has a top and bottom edge. The top and bottom edges have a wave-like formation created by peaks and troughs.

### RELATED APPLICATION

The present patent application claims the benefit of the filing date under 35 U.S.C. § 119(e) of Provisional U.S. Patent Application Ser. No. 61/127,552 filed May 14, 2008, which is hereby incorporated by reference.

### BACKGROUND

Hot and cold beverages and food (e.g., coffee, tea, soft drinks, soup, ice cream, and the like) may present a handling problem to consumers when dispensed into containers such as drinking cups. For example, paper, plastic, and foam drinking cups often do not provide sufficient thermal insulating properties when filled with hot or cold beverages. As a result, handling of such containers may be uncomfortable to the consumer.

### BRIEF SUMMARY

A sleeve is disclosed with a unique wave-like shape. Sleeves are sometimes used to supplement the thermal insulating properties of containers by, for example, reducing the rate of heat transfer between a container and a hand gripping the container.

The sleeve may encircle a container and provide comfortable handling of hot or cold containers. The sleeve may provide protection approximating that of sleeves not having the wave-like shape while using less manufacturing materials and may thus reduce the environmental impact of sleeve manufacturing.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a perspective view of a sleeve assembled with a cup.

FIG. 2 is a back view of a sleeve assembled with a cup.

FIG. 3 is a front view of a collapsed sleeve, unassembled from a cup.

FIG. 4A is a front view of a blank for a sleeve.

FIG. 4B is a back view of a blank for a sleeve.

FIG. 5A is a front view of a row of blanks for a sleeve arranged on sheet material.

FIG. 5B is a front view of a row of sleeve blanks without a wave-like shape arranged on sheet material.

FIG. 6 is a flow diagram of a method of making a sleeve.

### DETAILED DESCRIPTION

A sleeve for use with a container is disclosed. When placed on a container the sleeve may provide a thermal barrier between the container and a hand of a user. The thermal barrier may protect the user's hand from the temperature of the container. Alternatively or additionally, the thermal barrier may decrease heat transfer across the wall of the container and may thereby maintain the temperature of the container contents.

The sleeve may have a wave-like shape of peaks and troughs. The shape of the peaks and troughs may be, for example, square, arcuate, circular, or triangular, or any other shape. The width of the sleeve from peak to trough approximates the width, for example, of at least two fingers of human hand, and the shape may accommodate placing a thumb and at least two fingers on the sleeve. The sleeve may be sized to fit an adult or child container.

The wave-like shape of the sleeve may use reduced sheet material as compare to sleeves without a wave-like shape. Reducing the amount of sheet material used in manufacturing sleeves may cause waste reduction, which may be better for the environment.

Further, the wave-like shape of the sleeve may be more efficient to manufacture than sleeves which adapt to the shape of a conical cup by the expansion of slits, notches, honeycomb structures, or otherwise. For example, the wave-like shape may reduce the complexity of the die-cutting or other manufacturing processes.

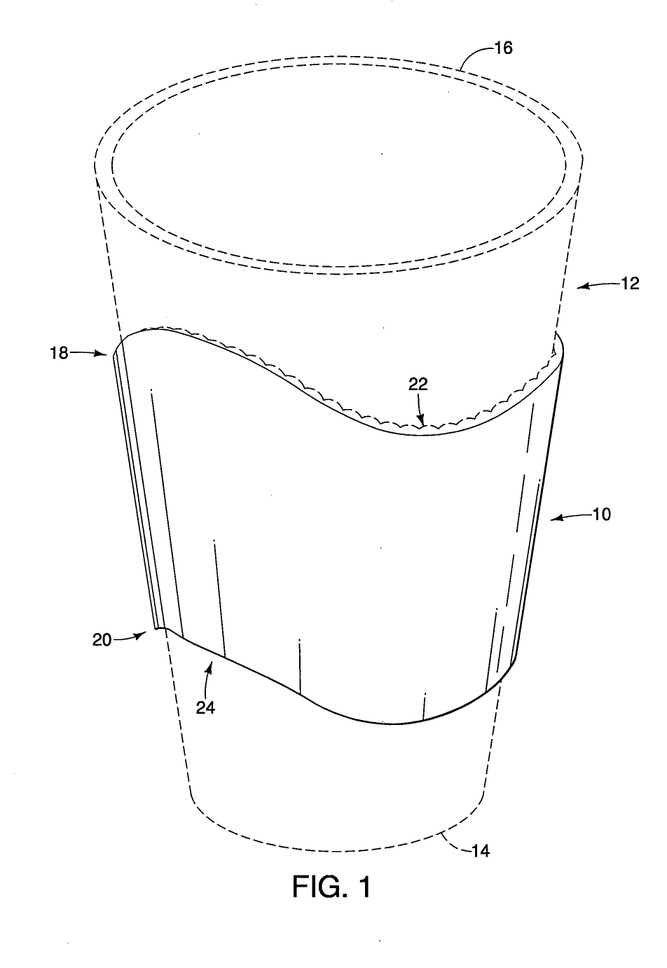

A sleeve 10 may be positioned in combination with a container 12 as in FIG. 1. The container 12 may be of any shape (e.g., tapered, non-tapered, square, rectangular, etc.) and may have a base 14 and a rim 16. The container 12 may be manufactured of plastic, foam, paper, or any other material, and may be adapted to hold hot or cold food or beverages.

The sleeve 10 may be assembled with the container 12 where the sleeve 10 fully encircles the circumference of the container 12. The sleeve 10 may be manufactured of, for example, paperboard, cardboard, plastic, foam, cellulosic fiber, wood, or any other materials. The sleeve 10 may also be coated internally or externally with, for example, heat-sensitive glues, printing, water proof material, and etc.

The sleeve 10 may include a first edge 18 and a second edge 20, which may be the top and bottom of the sleeve, or vice versa. The first edge 18 and second edge 20 may have a series of peaks 24 and troughs 22. The peaks 24 and troughs 22 may give the sleeve 10 a wave-like shape. Alternatively, the shape of the peaks 24 and troughs 22 may be, for example, square, or triangular, or any other shape. The peaks 24 and troughs 22 may be parallel to each other and may facilitate manufacturing ease and efficiency.

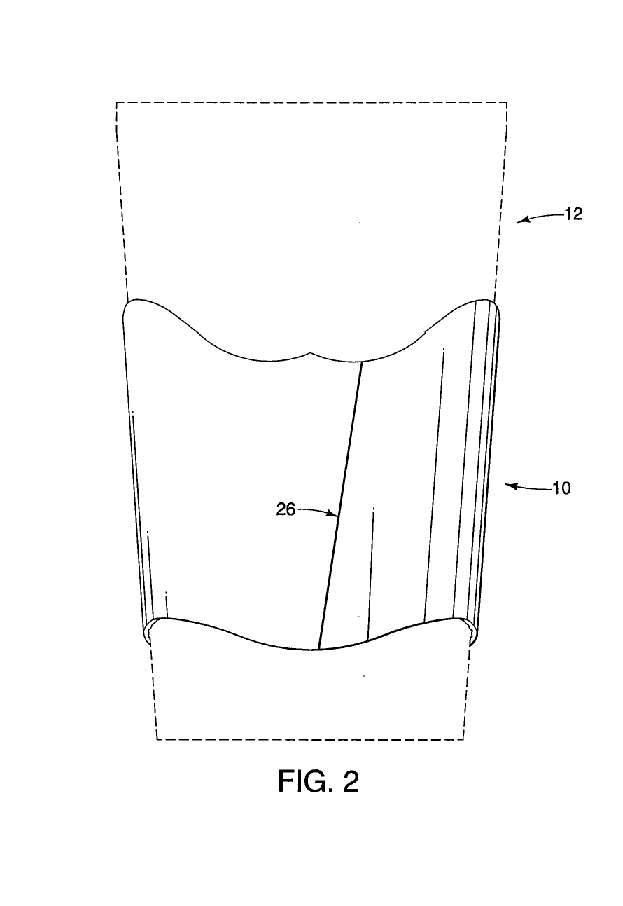

In FIG. 2 the sleeve 10 is combined with a container 12 in a manner that illustrates the joined ends 26 of the sleeve. The sleeve 10 may be formed by wrapping an elongate blank around a container 12. The ends of the sleeve 10 may be fastened together 26 to form a continuous circle. The joined ends 26 of the sleeve may be fastened by, for example, glue. The sleeve 10 may be configured to closely embrace the container 12 and may protect the user's fingers from high temperatures. For example, when assembled, the sleeve 10 may be tapered and may closely embrace a tapered container 12 without the formation of bulges in the sleeve where the sleeve 10 is not in contact with the container 12. The reduction of bulges may permit a container 12 combined with a sleeve 10 to maintain a slim profile. Maintaining the profile of a container 12 may facilitate inserting the combined container 12 and sleeve 10, for example, into car container holders.

The wave-like shape of the sleeve 10 may provide superior comfort and insulation over other sleeve designs, for example, sleeve designs which conform to a cup by expansion of a number of slits, notches, a honeycomb structure or otherwise. Sleeves that rely on expansion of slits may leave gaps in which the sleeve does not cover the container. These gaps may reduce comfort and insulation by leaving exposed areas of the container. Furthermore, a sleeve relying only upon slits, notches, or honeycombed structures, by virtue of leaving exposed areas of the container, may have reduced ability to maintain the temperature of the container contents. The wave-like shape of the sleeve 10 may provide a balance between material reduction and maintenance of thermal properties.

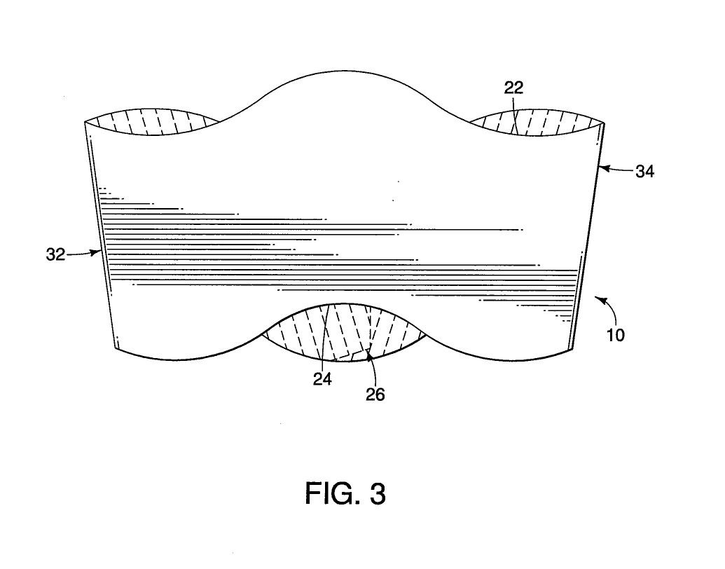

In FIG. 3, the sleeve 10 may contain fold lines, 32 and 34, such that, when unassembled from a cup, the sleeve 10 can be collapsed into a flat plane. Collapsing into a flat plane may permit the sleeves to be efficiently packed in ready-to-use form. The flat-plane form of the sleeve 10 may also provide efficiencies for storing, for example, on counter tops, in storage containers, in boxes, on shelves, and etc.

The sleeve 10 may be converted from collapsed form to uncollapsed form by, for example, pushing inward on the fold lines 32 and 34. The uncollapsed form of the sleeve 10 may define an opening through which a container 12 may be inserted.

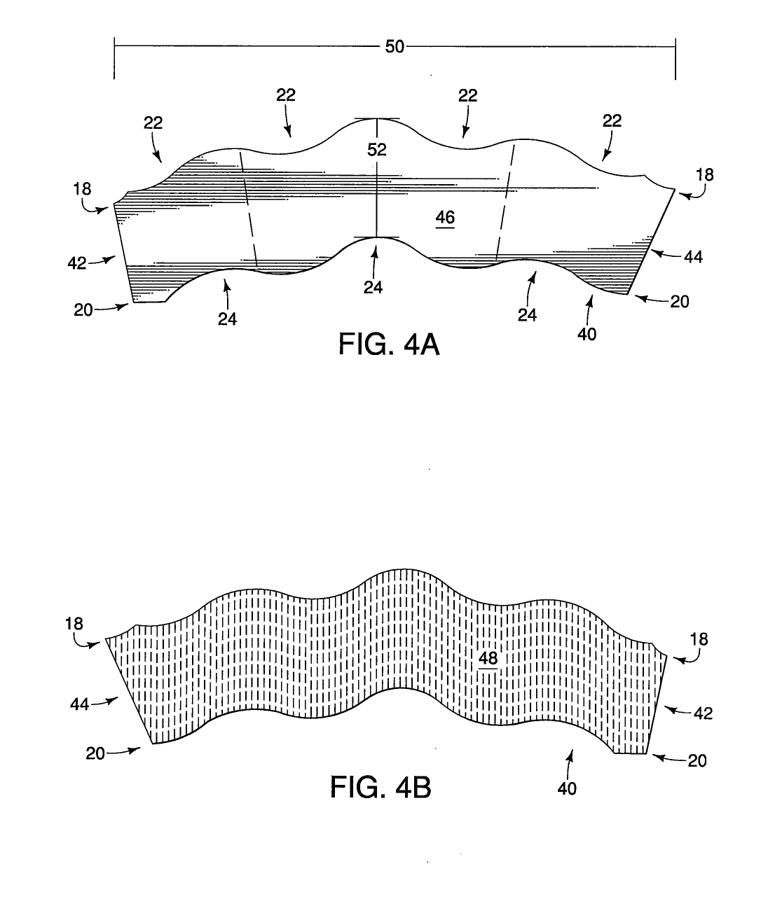

FIG. 4A is a front view of an exemplary blank 40 of the sleeve 10. In the blank 40, the right 44 and left 42 ends of the sleeve 10 are unassembled. The blank 40 of the sleeve 10 may include an elongate body with a generally planar outer surface 46 and a generally planar inner surface FIG. 4B, 48 for contacting the container. The blank of the sleeve 40 may have a first edge 18 and a second edge 20. The top edge 18 and bottom edge 20 may have a series of peaks 24 and troughs 22. The peaks 24 and troughs 22 may give the blank 40 of the sleeve 10 a wave-like shape. Alternatively, the shape of the peaks 24 and troughs 22 may be, for example, square, or triangular, or any other shape.

In a first embodiment, the first edge 18 of the blank 40 of the sleeve 10 may have at least two peaks 24 and one trough 22 relative to the second edge 20. In a second embodiment, the second edge 20 of the blank 40 of the sleeve 10 may have at least two peaks 24 and one trough 22 relative to the first edge 18. In a third embodiment, the peaks 24 of the first edge 18 may correspond to the troughs 22 of the second edge 20. In a fourth embodiment, the peaks 24 of the second 20 edge may correspond to the troughs 22 of the first edge 18. In a fifth embodiment, the peaks 24 and troughs 22 may create a generally s-shape wave. In a sixth embodiment, the peaks 24 and troughs 22 may be parallel. More or less peak 24 and troughs 22 may be used.

The wave-like shape may facilitate ease in manufacturing. There only need be one cut line between the sleeves, with no material lost between the sleeves as there may be no gaps between the unseparated sleeves. The wave-like shape may reduce the amount of source material consumed during manufacturing while maintaining similar handling protection to sleeves without the wave-like shape. Material reduction may reduce the environmental impact of sleeve manufacturing. Material reduction may also reduce the costs of production.

Either surface 46 or 48 of the sleeve 10 may be, for example but not limited to, smooth, fluted, corrugated, embossed, debossed, printed, waxed, and/or lined with foam, plastic, paper, glue, or any other material.

The blank of the sleeve 10 may have, for example but not limited to, a length 50 of approximately 9.5-11 inches. Alternatively, the length of the blank of the sleeve 10 may be dimensioned for a child-size container, an over-sized container, or any other size or shaped container. The blank of the sleeve 10 may have, for example but not limited to, a height 52 of approximately 1.8-2.5 inches. Alternatively, the height of the blank of the sleeve 10 may be dimensioned for a child-size container, an over-sized container, or any other sized or shaped container. The height 52 of the blank of the sleeve 10 may remain constant or may vary over its length 50.

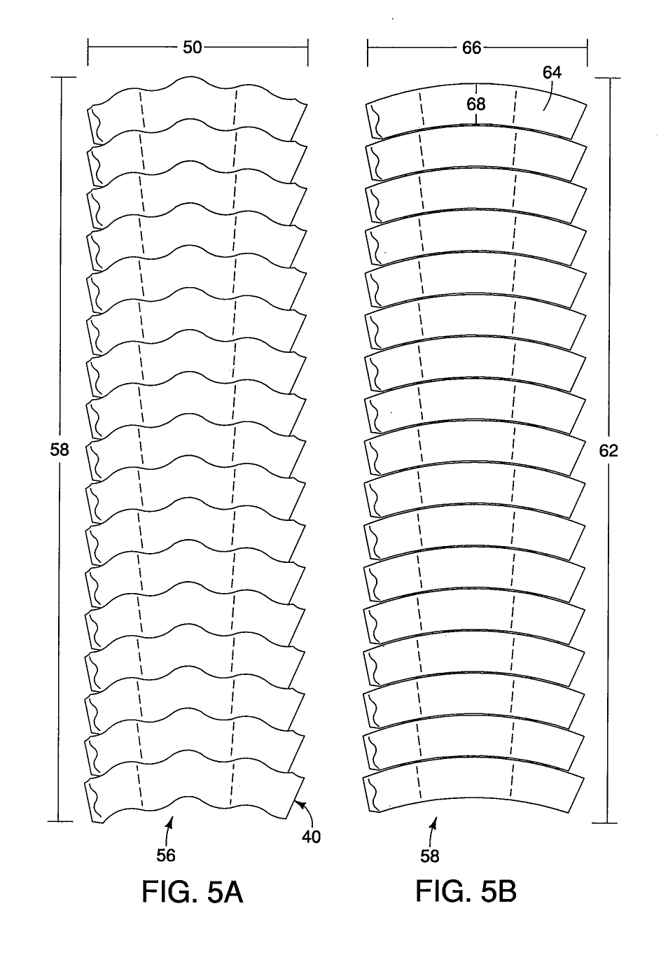

FIG. 5A shows an exemplary arrangement 56 of blanks 40 of the sleeve 10, for example, as cut lines on sheet material. A dimension of the sheet material, for example, a column length, is illustrated by 58.

Sheet material may contain one or more blanks 40 of a sleeve 10. The blanks 40 may be positioned on the sheet material in a repeating pattern such that the top and bottom edge portions of each sleeve shares a cut line such that there is not gaps between the sleeves.

FIG. 5B shows an exemplary arrangement 60 of blanks 64 of sleeves without the wave-like shape, for example, as cut lines on sheet material. A dimension of the sheet material, for example, a column length, is illustrated by 62.

The blanks 64 of the sleeves without the wave-like shape may have a height 68 of, for example but not limited to, 1.8-2.5 inches. The blanks 64 of the sleeves without the wave-like shape may have a length of, for example but not limited to, 9.5-11 inches.

FIG. 5A & 5B together illustrate the potential material efficiencies of the wave-like shape versus a non-wave like shape. For example, a given sheet material may have dimension 58 and 62, where 58 and 62 are of approximately equal dimension (e.g., up to +/−1% variance). The sheet material 5A may contain blanks 40 of the sleeve 10 with the wave-like shape. The sheet material 5B may contain blanks 64 of a sleeve without the wave-like shape. The blank 40 may be of approximately equal dimension as the blank 64 of the sleeves without the wave-like shape (e.g., up to +/−1% variance of height and/or length). A dimension 58 of sheet material may accommodate, for example, from about ten (10) percent to about forty (40) percent more blanks 40 of the sleeve 10 with the wave-like shape than a dimension 62 of the blanks 64 of sleeves without the wave-like shape. For example, a dimension 58 of sleeve blanks 40 with a wave-like shape may accommodate 17 sleeves as compared the 13 sleeves accommodated by an approximately equal dimension 62 of sleeve blanks 64 without a wave-like shape. Accordingly, a sleeve 10 with a wave-like shape may reduce material use, manufacturing waste, environmental impact and decrease material costs.

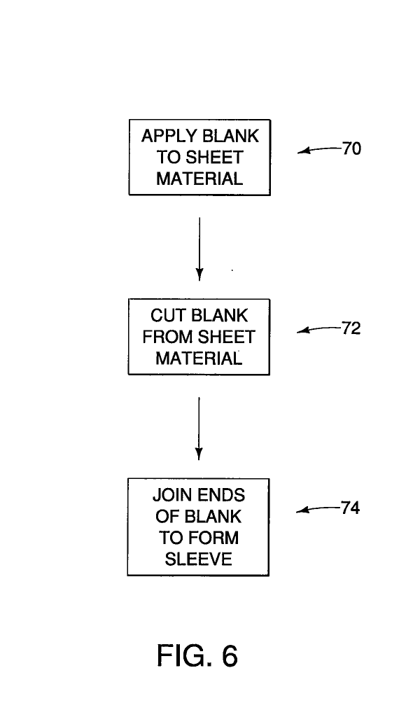

FIG. 6 shows an exemplary method for forming a sleeve 10. Box 70 may contain a step of applying a blank 40 to a sheet material, for example, with cut lines; box 72 may contain a step of cutting the blanks 40 from the sheet material; and box 74 may contain the step of joining the ends of the blank 40 to form a sleeve 10.

While various embodiments of the invention have been described, it will be apparent to those of ordinary skill in the art that many more embodiments and implementations are possible that are within the scope of the invention.

We claim:

1. A sleeve for use with a container, comprising:
a blank having a first edge and a second edge, and
the first edge including at least two peaks and one trough with regard to the second edge.

2. The sleeve of claim 1, further comprising a first edge and a second edge that defines a wave-like shape.

3. The sleeve of claim 1, further comprising:
a first edge and a second edge, and
where the peaks of the first edge corresponding to the troughs of the second edge.

4. The sleeve of claim 1, further comprising the peaks of the first edge and the troughs of the second edge in parallel.

5. The sleeve of claim 1, further comprising a first edge with three peaks and comprising three troughs, and a second edge comprising three peaks and comprising three troughs, wherein the peaks of the first edge correspond to the troughs of the second edge.

6. The sleeve of claim 1 where the sleeve completely conceals the covered area of the container.

7. The sleeve of claim 6 further comprising a width of the sleeve from a peak to a trough.

8. The sleeve of claim 7 where the width of the sleeve accommodates at least two fingers and a thumb of a human hand.

9. The sleeve of claim 1 wherein the peaks and troughs comprise a shape chosen from a square, a triangle, or a circle.

10. A method for forming a sleeve, comprising:
applying a blank to a sheet material,
the blank comprising a blank having a first edge and a second edge,
the first edge including at least two peaks and one trough with respect to the second edge.

11. The method of claim 10 wherein the blank further comprises a first edge and a second edge that defines a wave-like shape.

12. The method of claim 10 wherein the blank further comprises a first edge and a second edge, and where the peaks of the first edge corresponding to the troughs of the second edge.

13. The method of claim 10 wherein the blank further comprises the peaks of the first edge and the troughs of the second edge in parallel.

14. The method of claim 10 wherein the blank further comprises a first edge with three peaks and comprising three troughs, and a second edge comprising three peaks and comprising three troughs, wherein the peaks of the first edge correspond to the troughs of the second edge.

15. The method of claim 10 further comprising cutting the blanks from the sheet material.

16. The method of claim 10 further comprising joining the ends of the blank to form a sleeve.

17. A sheet material comprising one or more blanks of a sleeve for encircling a container, comprising:
A blank having a first edge and a second edge, and
the first edge including at least two peaks and one trough with regard to the second edge
positioning a repeating pattern of the sleeve on sheet material such that the top and bottom edge portions of each sleeve shares a cut line such that there is not gaps between the sleeves.

18. The sheet material of claim 17 wherein a dimension of sheet material accommodates about ten percent to about forty percent more blanks of the wave-like sleeve than a dimension of the blanks of sleeves that do not include a wave-like form.

19. The sheet material of claim 17 further comprising paperboard.

20. The sheet material of claim 19 where the paperboard is biodegradable.
